(19) United States
(12) Patent Application Publication
(10) Pub. No.: US 2013/0011519 A1
(43) Pub. Date: Jan. 10, 2013

(54) ELECTROLYTE CONCENTRATE FOR PRODUCING HYDRATION BEVERAGES

(76) Inventor: Val J. Anderson, Ogden, UT (US)

(21) Appl. No.: 13/346,512

(22) Filed: Jan. 9, 2012

Related U.S. Application Data
(60) Provisional application No. 61/430,991, filed on Jan. 8, 2011.

(51) Int. Cl. A23L 2/52; A23L 1/304

(52) U.S. Cl. 426/66; 426/74

(57) ABSTRACT

An electrolyte concentrate for producing hydration beverages can include a sea water concentrate which includes natural minerals. A zinc mineral salt is also included as a primary supplemental mineral, while a potassium mineral salt serves as a secondary supplemental mineral. Further, a citric acid is provided in an amount sufficient to lower a pH of the electrolyte concentrate below about 3.0. The electrolyte concentrate can be particularly useful in forming hydration beverages for athletes and individuals to provide rehydration and nutritional benefits with improved flavor and no added sugar.

### RELATED APPLICATION

This application claims benefit of U.S. Provisional Application No. 61/430,991, filed Jan. 8, 2011 which is incorporated herein by reference.

### BACKGROUND

Electrolyte beverages can provide consumers with hydration to replenish mineral levels such as potassium and sodium. Individuals can benefit from such electrolyte therapy after exercise, excessive exertion, vomiting, intoxication, or the like. Most common electrolyte beverages are sports drinks and the like which contain substantial quantities of sugar. More recently, pure electrolyte solutions have been used but lack flavoring and exhibit mediocre palatability.

### SUMMARY

An electrolyte concentrate for producing hydration beverages can include a sea water concentrate which includes natural minerals. A zinc mineral salt is also included as a primary supplemental mineral, while a potassium mineral salt serves as a secondary supplemental mineral. Further, a citric acid is provided in an amount sufficient to lower a pH of the electrolyte concentrate below about 3.0.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Definitions

In describing and claiming the present invention, the following terminology will be used.

The singular forms “a,” “an,” and “the” include plural referents unless the context clearly dictates otherwise. Thus, for example, reference to “an electrolyte” includes reference to one or more of such materials and reference to “mixing” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein “sea water” refers to water obtained from a sea, where “sea” refers to a natural body of salt water such as an ocean, a smaller body of salt water that is more or less landlocked, or an inland body of salt water such as a large salt water lake. Sea water may come from one sea or be a mixture of water from one or more seas. Non-limiting examples of seas include the Great Salt Lake, the Dead Sea, and any one of the world's oceans. However, seas having concentrated levels of salt substantially above that of the world's open oceans are often useful from a point of production efficiency and product purity. Isolated seas tend to have significantly fewer contaminants communicated from other water sources and tend to exhibit lower concentrations of heavy metals which tend to precipitate in such seas.

As used throughout, the term “sea water concentrate” is distinct from the “electrolyte concentrate.” In particular, the sea water concentrate is an ingredient used in conjunction with other components to form the electrolyte concentrate. Thus, when referring to the sea water concentrate, percentages and content are relative to the sea water concentrate exclusive of the other components rather than of the electrolyte concentrate.

As used herein, “minerals” refer to any of a number of inorganic biologically useful elements, compounds, or electrolytes which are necessary for at least one biological function. Minerals can include elements, halides, compounds thereof, and ions thereof. In some cases these minerals can be present in a base state, while frequently the minerals may be present in an oxidized or reduced state as electrolytes, e.g. Ca⁺², Mg⁺², I⁻, Cl⁻, etc. The term “natural minerals” refers to those minerals which are present as found naturally, i.e. without isolation, purification, or modification. Conversely, the term “supplemental minerals” refers to minerals which are added using a specialized or dedicated source of the particular mineral. Thus, for example, manganese is often present in salt water; however, supplemental manganese can be added by an appropriate salt, e.g. manganese gluconate. Both essential and beneficial minerals can be used in the present invention.

As used herein, “essential minerals” include those which are currently recognized by the FDA as essential to various biological functions within the human body. Currently, the essential minerals include potassium, magnesium, sodium, iodine, zinc, selenium, copper, manganese, chromium, molybdenum, chloride, calcium, fluoride, iron, and phosphorus. Similarly, “beneficial minerals” include those minerals which appear to exhibit positive effects on the human body but have not yet been officially recognized as essential or beneficial to particular biological functions. Non-limiting examples of beneficial minerals include boron, silicon, vanadium, arsenic, strontium, cobalt, germanium, and tin.

As used herein, “mineral compound” refers to a chemical compound which includes a mineral. Mineral compounds can include, but are not limited to, mineral salts and compounds such as mineral oxides. However, suitable mineral compounds can be nutritionally acceptable forms or sources of the respective minerals.

As used herein, “mineral salt” refers to a mineral coupled with a corresponding ion to form a compound. For example, the mineral zinc can be associated with sulfate to form the corresponding salt compound zinc sulfate. Similarly, the anionic mineral iodine can be associated with a cationic mineral potassium in the form of potassium iodide salt. Thus, one or both ionic portions of the salt can be “minerals” as used in context of the present invention.

As used herein, “trace amounts” refer to amounts which are insufficient to support an RDA label claim or foreign nutritional equivalent and/or exhibit a nutritionally significant effect. Although this trace amount can vary depending on the component, generally trace amounts are less than about 0.05% by weight of a composition.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

An electrolyte concentrate for producing hydration beverages can include a sea water concentrate which includes natural minerals. A zinc mineral salt is also included as a primary supplemental mineral, while a potassium mineral salt serves as a secondary supplemental mineral. Further, a citric acid is provided in an amount sufficient to lower a pH of the electrolyte concentrate below about 3.0.

The sea water concentrate may be obtained through the evaporation of sea water to achieve desired or predetermined mineral concentrations. Evaporation can be accomplished by natural techniques, such as by collecting sea water in solar evaporation ponds. Alternatively, evaporation may be accelerated, initiated, completed, or accomplished using artificial techniques such as by exposing collected sea water to radiative or conductive heat, spraying, or by convective evaporation. In one embodiment, evaporation occurs in solar evaporation ponds. After the appropriate amount of evaporation has occurred, the supernatant is then retained as the desired sea water concentrate, and the precipitate discarded, sold, or otherwise used in other processes.

As evaporation of an amount of sea water progresses, the minerals dissolved or suspended therein become generally more concentrated. One result of this general increase in concentration is that certain minerals reach saturation and begin to precipitate out of solution. Typically, sodium and potassium are the first to precipitate out with their associated anions, mostly chloride. Other mineral ions, such as magnesium, are less prone to precipitate and therefore are present in the final sea water concentrate in concentrations that are higher than those present initially in the sea water. Therefore, the constituency of the sea water concentrate can be determined by the duration and extent of evaporation relative to the initial volume of sea water. For example, a shorter evaporation time yields a concentrate having a greater amount of sodium, potassium and water, while a longer evaporation time yields a concentrate having less sodium, potassium and water. Regardless of the amount of evaporation that takes place, the resulting sea water concentrate should still be in a liquid state. This liquid is at approximate to full saturation for most if not all of the components contained. It may be possible to increase the amounts of individual minerals but it would likely come at the expense of reducing content of other minerals. Thus, in one optional aspect, a majority of the natural minerals are fully saturated in the sea water concentrate. In another optional aspect, substantially all of the natural minerals are fully saturated in the sea water concentrate.

Alternatively, the natural minerals and supplemental minerals can be introduced by concentrating a first volume of salt water obtained from a naturally occurring body of salt water. The naturally occurring body of salt water can be any salt water body such as, but not limited to, the Great Salt Lake, the Dead Sea, Pacific Ocean, Atlantic Ocean, Yuncheng Salt Lake, and the like. In one aspect, the sea water concentrate can be formed from an inland body of sea water. Concentration of the salt water can be accomplished by evaporation ponds, distillation, or other suitable methods to remove at least a first portion of water from the first volume to form a moderate brine concentrate. In most cases, the method of concentration can be substantially free of chemical additives and can avoid introduction of non-mineral or water components. Accordingly, evaporation ponds and distillation methods can be particularly suitable. Although concentrations can vary considerably, the moderate brine concentrate can have from about 5 mg/mL to about 35 mg/mL magnesium, and often from about 9 mg/mL to about 25 mg/mL. The moderate brine solution can have at least three natural minerals of potassium, sodium, and magnesium, and often has other trace minerals which can include essential and/or beneficial minerals. Depending on the body of salt water used as the source, trace minerals can also be present such as, but not limited to, lithium, sulfur, strontium, silicon, tin, arsenic, and rubidium. Some trace minerals can be beneficial while others may require additional treatment to remove and/or reduce sufficient to meet commercially desirable levels and/or governmental guidelines. This moderate brine solution can then be mixed with a strong brine solution to obtain a desired concentration of minerals.

Using salt water obtained from natural resources can make adjusting concentrations of various minerals difficult in some respects. In particular, concentrations of minerals can vary from month to month, depending on climate, water currents, and other variables.

The resulting sea water concentrate typically will contain a lowered amount of sodium and potassium relative to the original levels, while containing increased concentrations of other elements, particularly magnesium. The magnesium may be present mainly as dissolved magnesium chloride and magnesium sulfate. Especially when using natural techniques for concentration, the desired target concentrations of various minerals may be difficult to achieve. Therefore, in some embodiments highly concentrated product can be mixed with a lower concentration product in calculated ratios to achieve the desired final target values.

Sea water also typically contains numerous other minerals, though the exact constituency depends upon the body of water from which it is taken. Accordingly, the sea water concentrate may contain one or more essential trace elements, such as, but not limited to, chromium, cobalt, copper, iodine, iron, manganese, molybdenum, selenium, zinc, boron, fluoride, germanium, lithium, nickel, rubidium, strontium, tin, and vanadium. In some embodiments, the concentrate product can include twelve or more essential trace elements. In other embodiments, most elements found in columns (subgroups) 1-18 of the periodic table up to element 90 (Th) can be included in the essential trace elements to form a full spectrum of minerals including substantially all naturally occurring minerals salts as are found in trace amounts in sea water. Thus, in some embodiments the sea water concentrate can include aluminum, antimony, arsenic, barium, beryllium, bismuth, boron, bromine, cadmium, calcium, carbon, cerium, cesium, chloride, cobalt, copper, dysprosium, erbium, europium, fluorine, gadolinium, gallium, germanium, gold, hafnium, holmium, hydrogen, indium, iodine, iron, lanthanum, lead, lithium, lutetium, magnesium, manganese, mercury, molybdenum, neodymium, nickel, niobium, nitrogen, oxygen, phosphorus, platinum, potassium, praseodymium, rhenium, rubidium, samarium, scandium, selenium, silicon, silver, sodium, strontium, sulfur, tantalum, tellurium, terbium, thallium, thorium, thulium, tin, titanium, tungsten, uranium, vanadium, ytterbium, yttrium, zinc, and zirconium, inclusive, as essential trace elements. Furthermore, in some embodiments, argon, helium, krypton, neon, and xenon can also be present as essential trace elements.

By obtaining concentrates from a common salt water source, fewer processing steps are thus involved in production of the composition and allow for a more natural balance of the primary minerals with other naturally occurring, beneficial trace elements.

In yet another alternative, sea water concentrate, sodium chloride or sea salt can be used for the sodium contribution instead of the sea water concentrate.

Additional components of the electrolyte concentrate can be provided by directly adding such components to the sea water concentrate. For example, the zinc mineral salt can most often be provided as a solid although other liquid sources can be used. The zinc mineral salt can be provided as zinc sulfate, zinc chloride, zinc gluconate, zinc citrate, or combinations thereof, although other zinc salts may be suitable if they are non-toxic and provide zinc ions in solution. In one specific example, the zinc mineral salt is zinc sulfate. The amount of zinc in the electrolyte concentrate can be varied. However, as a general rule, the zinc mineral salt is present sufficient to obtain a zinc concentration from about 0.4 mg/ml to about 0.8 mg/ml in the electrolyte concentrate. In one example, the zinc mineral salt is present to achieve a zinc concentration from about 0.50 mg/ml to about 0.60 mg/ml in the electrolyte concentrate.

Zinc is also an essential nutrient for energy conversion as well as for other body functions. The body does not have a storage system for zinc which makes zinc readily available for various body functions including energy conversion and immune function. For this reason, individuals need to consume zinc as needed on a daily basis or throughout the day. This can be a bit problematic with zinc as over consumption of zinc can cause nausea. This makes low dose supplementation of zinc through beverages ideal for athletes, much as it is for electrolytes. The more fluids that an athlete or individual needs to consume, the more electrolytes and zinc that athlete or individual will generally need to consume. The World Health Organization has also recommended zinc supplementation along with Oral Rehydration Salts for those around the world who are at risk of death from acute diarrhea, but they do not include the zinc with the ORS, but rather recommend separate supplementation with zinc. The electrolyte concentrate provides a convenient and heretofore unconsidered avenue for providing zinc mineral simultaneously with rehydration electrolytes.

Similarly, the potassium mineral salt can be provided from a solid although liquids can be useful. Non-limiting examples of suitable potassium mineral salts include potassium chloride, potassium iodide, and combinations thereof. In one example, the potassium mineral salt is potassium chloride. As with other components, the concentration of potassium mineral salt can vary. For example, the potassium mineral salt can be present sufficient to provide a potassium concentration from about 30 mg/ml to about 50 mg/ml. In another aspect, the potassium mineral salt can be present so as to provide a potassium concentration from about 40 mg/ml to about 46 mg/ml.

Further, the citric acid can also be directly added to the sea water concentrate. The amount of citric acid added can be sufficient to lower a pH of the electrolyte concentrate to below about 3.0. Thus, the content of citric acid can be high enough to provide a masking flavor to the concentrate once diluted as a hydration beverage while also enhancing resistance to growth of bacteria. As such, the electrolyte concentrate and resulting hydration beverages can be substantially or completely free of added sugar or inherent sugar. Although other concentrations can be suitable, the citric acid can be present from about 60 mg/ml to about 100 mg/ml, such as from about 78 mg/ml to about 90 mg/ml. In one aspect, the amount is sufficient to achieve a pH of below about 2.0.

In one optional embodiment, the electrolyte concentrate can consist of the sodium mineral salt from a salt water concentrate, the zinc mineral salt, the potassium mineral salt and the citric acid. In such cases, no additional preservatives, colorants, additives, sugars or other components are included.

Additional components can optionally be added to the electrolyte concentrate. For example, a magnesium mineral salt can be added as a tertiary supplemental mineral. Magnesium chloride or magnesium sulfate can be used for the magnesium contribution, although other magnesium mineral salts can be used as long as it is non-toxic and provides magnesium ions in solution. With respect to one embodiment of the present invention, substantially no magnesium is added at any point other than magnesium which is inherently present in the salt water source. Alternatively, or in addition, the electrolyte concentrate is substantially free of iron, boron, iodine, and/or calcium.

Similarly, supplemental minerals can be introduced in amounts which are biologically active and reach predetermined concentration levels. The supplemental minerals can include essential and/or beneficial minerals. Currently, exemplary essential minerals include potassium, magnesium, sodium, iodine, zinc, selenium, copper, manganese, chromium, molybdenum, chloride, calcium, fluoride, iron, and phosphorus. Similarly, beneficial minerals can include, but are not limited to, boron, silicon, vanadium, arsenic, strontium, cobalt, germanium, and tin. These supplemental minerals can be provided from any suitable source such as a corresponding mineral compound such as a mineral salt or from a natural salt water source. Non-limiting examples of suitable mineral salts can include potassium iodide, zinc sulfate, sodium selenate, copper gluconate, manganese gluconate, chromic chloride, sodium molybdate, sodium chloride, potassium chloride, boric acid, and sodium borate. Other supplemental minerals can be provided by compounds such as chlorides, sulfates, or gluconates, of strontium, vanadium, silicon, arsenic, tin, or the like. The supplemental minerals can be optionally obtained from independent compositional sources from that of the primary minerals, e.g. the naturally occurring body of salt water. For example, commercially available salts, pure food grade compounds, etc. can be selected for incorporation into the electrolyte concentrate. In some embodiments, at least five or six supplemental minerals can be obtained from independent sources.

An optional preservative can be present in an amount sufficient to reduce or eliminate growth of organisms and increase useful shelf-life. The preservative can be introduced at any suitable point in the process and is often done after preparation of the mineral-laden solution as one of the final steps in the method of making the electrolyte concentrate. In addition, suitable preservatives can also be chosen to preserve the balanced and non-toxic nature of the electrolyte concentrate. Alternatively, pasteurizing or heat treatments can be performed to significantly reduce the presence of organisms in the concentrate sufficiently to prevent undesirable levels within a predetermined shelf-life. Non-limiting examples of suitable preservatives can include calcium propionate, sodium nitrate, EDTA, benzoates, ascorbic acid, vitamin C, and the like. Natural preservatives such as ascorbic acid can be particularly useful. The specific amounts of preservatives can vary depending on the composition. For example, ascorbic acid can be useful in amounts from about 0.8-1.25 mg/mL, such as about 1.06 mg/mL, although other concentrations can also be used.

Further, the sea water concentrate or the electrolyte concentrate can be treated to substantially retain the natural minerals and supplemental minerals in solution. Suitable treatments can include, but are not limited to, introducing a solubilizing agent, heating, and/or adjusting concentrations of mineral compounds. Accordingly, an optional solubilizing agent can also be present in an amount sufficient to substantially retain the primary minerals and supplemental minerals in solution. Depending on the particular mineral compounds present and the respective concentrations, a solubilizing agent can prevent significant precipitation of mineral compounds out of solution. Solubilizing agents can include any components which increase solubility of the mineral and constituent components of the composition and prevent formation of precipitatable compounds, e.g. by pH control, chelation, etc. In particular pH control solubilizing agents are can be used. Non-limiting examples of suitable solubilizing agents can include weak organic acids such as ascorbic acid. Conveniently, in some compositions the preservative and the solubilizing agent can have the same chemical identity. For example, citric acid and ascorbic acid can act as both preservatives and solubilizing agents.

Among the various methods recited above for forming the electrolyte concentrate, the order of concentrating, purifying, mixing, adding, etc. can be varied according to need and convenience. However, the steps can be optionally performed in the order recited above. In some embodiments of the present invention, one or more steps can include a heating step in order to either keep minerals in solution and/or to dissolve mineral crystals which may have formed during processing.

The electrolyte concentrate can be formed using methods which are substantially free of any heating which reduces energy usage and can reduce overall complexity and necessary process equipment. In another alternative, all of the materials used and/or added to the electrolyte concentrate can be food grade products suitable for human consumption. More particularly, all components can further be kosher, vegetarian, and/or vegan.

A method of using the electrolyte concentrate can include diluting the electrolyte concentrate in water to form a hydration beverage. The ratio of electrolyte concentrate to water can vary depending on personal preferences and performance goals. However, as a general guideline, a mixing ratio of electrolyte concentrate to water of about 1 to 8 oz : 4 to 6 gallons can be typical. In one example, the ratio is about 1 to 4 oz : 5 gallons, while in another example the ratio is about 2 oz : 5 gallons. The hydration beverage can also exhibit a relatively low pH. For example, the mixing ratio can be sufficient to achieve a hydration beverage pH from about 2.04 to about 3.07.

In one example, a base electrolyte concentrate is made with mineral ingredients from the Great Salt Lake, plus potassium chloride and purified water. A half teaspoon provides 45 mg/11% DV of magnesium, 130 mg/4% DV of potassium, 125 mg/5% DV of sodium, 390 mg/11% DV of chloride and 20 mg of sulfate. The electrolyte concentrate has significantly better flavor properties and with such is easier to use as the dosing range for palatability is much wider. All of the ingredients are functional to support athletic performance on a nutritional level and most of the components contribute to energy conversion such as supporting the Krebs cycle.

Also, one of the major benefits is that the electrolyte concentrate does not contain any added flavors (except citric acid) and it contains no sugars, such that it does not contribute to the growth of mold or bacteria. This is a major benefit for those using 5 and 10 gallon water dispensing systems as well as for those who use hydration packs in that cleaning and disinfecting of that equipment is a hassle and time consuming and because bacterial or mold growth can ruin that equipment which can be expensive.

The electrolyte concentrate, on top of not contributing to the growth of mold or bacteria has a pH, both in concentrate form as well as finished mixed beverage form which will actually retard the growth of mold and bacteria significantly, even compared with pure water. The concentrate has a pH that is actually more acidic than stomach acid. When mixed at the various levels, it can typically have a pH that ranges between 3.07 and 2.04.

The electrolyte concentrate formulation has a significant amount of citric acid added to the base electrolyte mix. For example, 10 grams of citric acid can be added to each 100 ml of base electrolyte concentrate mix. A small amount of water can be added so that the citric acid is fully soluble and remains in solution. The citric acid and water dilute the base electrolyte formula about 20% which changes the dosing recommendation slightly, such that 2 oz of finished mix is sufficient to make 5 gallons of electrolyte fueled hydration having desirable target ratios and levels of the major electrolytes. This makes the product very usable for athletic teams and work crews making 5 and 10 gallon mixes. In one example, a 1 gallon container with a measured pump can be used to dispense one ounce per full pump.

The tart flavor provided at least in part by the citric acid masks the salty flavor of the electrolytes very well and is shelf stable for at least 5-10 years. The citric acid is also an essential component of the KREBS cycle which is also known as the citric acid cycle. Citric acid, although it is acidic, is a mild alkalizer in the body which provides another benefit for endurance athletes who often get a sour stomach and have other issues of acidity within the body when exposing their bodies under high physical strain for long periods of time.

The electrolyte concentrate described herein can allow consumers to choose between the standard mixing ratios or to add as much as 4 times as much to suit their specific needs and tastes. The standard mix can provide one 3 ml serving in 32 oz of electrolyte water. The 3 ml serving can contain 130 mg of potassium, 125 mg of sodium, 45 mg of magnesium, 390 mg of chloride, 20 mg of sulfate, 1.65 mg of zinc. This serving would also provide approximately 250 mg of citric acid. Up to 10 servings may be consumed in a day without providing excessive amounts of either zinc or magnesium. At the high end of the range, a 3 ml serving (approximately 0.6 tsp) can be provided in 8 oz of finished drink. One specific example of the electrolyte concentrate uses whole great salt lake water, a low sodium, low potassium Great Salt Lake concentrate, purified water, potassium chloride, citric acid and zinc sulfate.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. An electrolyte concentrate for producing hydration beverages, comprising:
a) a sodium mineral salt in an aqueous solution;
b) a zinc mineral salt as a primary supplemental mineral in the aqueous solution;
c) a potassium mineral salt as a secondary supplemental mineral in the aqueous solution; and
d) a citric acid in the aqueous solution in an amount sufficient to lower a pH of the electrolyte concentrate below about 3.0.

2. The electrolyte concentrate of claim 1, wherein the sodium mineral salt is a sea water concentrate which includes natural minerals.

3. The electrolyte concentrate of claim 2, wherein the sea water concentrate is an inland sea water concentrate.

4. The electrolyte concentrate of claim 2, wherein a majority of the natural minerals are fully saturated in the sea water concentrate.

5. The electrolyte concentrate of claim 2, wherein substantially all of the natural minerals are fully saturated in the sea water concentrate.

6. The electrolyte concentrate of claim 1, wherein the zinc mineral salt is selected from the group consisting of zinc sulfate, zinc chloride, zinc gluconate, zinc citrate, and combinations thereof.

7. The electrolyte concentrate of claim 1, wherein the zinc mineral salt is zinc sulfate.

8. The electrolyte concentrate of claim 1, wherein the zinc mineral salt is present sufficient to provide a zinc concentration from about 0.4 mg/ml to about 0.8 mg/ml in the electrolyte concentrate.

9. The electrolyte concentrate of claim 1, wherein the zinc mineral salt is present sufficient to provide a zinc concentration from about 0.50 mg/ml to about 0.60 mg/ml in the electrolyte concentrate.

10. The electrolyte concentrate of claim 1, wherein the potassium mineral salt is selected from the group consisting of potassium chloride, potassium iodide, and combinations thereof.

11. The electrolyte concentrate of claim 1, wherein the potassium mineral salt is potassium chloride.

12. The electrolyte concentrate of claim 1, wherein the potassium mineral salt is present sufficient to provide a potassium concentration from about 30 mg/ml to about 50 mg/ml.

13. The electrolyte concentrate of claim 1, wherein the potassium mineral salt is present sufficient to provide a potassium concentration from about 40 mg/ml to about 46 mg/ml.

14. The electrolyte concentrate of claim 1, wherein the citric acid is present from about 60 mg/ml to about 100 mg/ml.

15. The electrolyte concentrate of claim 1, wherein the citric acid is present from about 78 mg/ml to about 90 mg/ml.

16. The electrolyte concentrate of claim 1, wherein the amount is sufficient to achieve a pH of below about 2.0.

17. The electrolyte concentrate of claim 1, further comprising a magnesium mineral salt as a tertiary supplemental mineral.

18. The electrolyte concentrate of claim 1, wherein the electrolyte concentrate is substantially free of sugar.

19. A method of using the electrolyte concentrate of claim 1, comprising:
a) diluting the electrolyte concentrate in water at a ratio of electrolyte concentrate to water of about 1 to 8 oz : 4 to 6 gallons to form a hydration beverage.

20. The method of claim 19, wherein the ratio is sufficient to achieve a hydration beverage pH from about 2.04 to about 3.07.

21. The method of claim 19, wherein the ratio is about 1 to 4 oz : 5 gallons.

22. The method of claim 19, wherein the ratio is about 2 oz : 5 gallons.
